(19) United States
(12) Patent Application Publication
(10) Pub. No.: US 2023/0251895 A1
(43) Pub. Date: Aug. 10, 2023

(54) INFORMATION PROCESSING APPARATUS AND CONTROL METHOD

(71) Applicant: Lenovo (Singapore) Pte. Ltd., Singapore (SG)

(72) Inventors: Ryohta Nomura, Kanagawa (JP); Yoshitsugu Suzuki, Kanagawa (JP)

(73) Assignee: Lenovo (Singapore) Pte. Ltd., Singapore (SG)

(21) Appl. No.: 18/152,156

(22) Filed: Jan. 10, 2023

(30) Foreign Application Priority Data
Feb. 7, 2022 (JP) 2022-017096

(51) Int. Cl. G06F 9/48; G06F 3/04883; G06F 3/04886

(52) U.S. Cl. CPC G06F 9/48; G06F 3/04883; G06F 3/04886

(57) ABSTRACT

An information processing apparatus includes a keyboard and a touch pad; a display unit which displays input information input through the keyboard and the touch pad; an input conversion processing unit which displays, on the display unit, input prediction candidates for key input through the keyboard; and a switching processing unit which switches the touch pad from a normal input mode to perform input processing as a normal pointing device to a gesture input mode to output a key code corresponding to each of specific keys including at least arrow keys and an enter key as a specific key corresponding to a specific gesture according to the specific gesture as a specific touch operation on the touch pad during a period in which the input conversion processing unit is displaying the input prediction candidates on the display unit.

### CROSS-REFERENCE TO RELATED APPLICATIONS

This application claims priority to Japanese Patent Application No. 2022-17096 filed on Feb. 7, 2022, the contents of which are hereby incorporated herein by reference in their entirety.

### BACKGROUND OF THE INVENTION

### Field of the Invention

The present invention relates to an information processing apparatus and a control method.

### Description of the Related Art

There are known information processing apparatuses, such as laptop personal computers (hereinafter, laptop PCs), each of which includes a keyboard and a touch pad as a pointing device (for example, see Japanese Unexamined Patent Application Publication No. 2018-010512).

By the way, in the conventional information processing apparatuses described above, attempts are being made to improve the productivity of text input through a keyboard and a touch pad. For example, there is known an information processing apparatus including an IME (Input Method Editor) or the like having a predictive input function. However, in such a conventional information processing apparatus, when the predictive input function is used, there is a need to select a prediction candidate by using the Tab key or the Enter key after highlighting the prediction candidate using an Arrow key, or using the cursor of a pointing device such as a mouse or a touch pad. Therefore, there is a possibility that user's hands are moved away from the home position of the keyboard. Especially, when a software keyboard with a smooth surface such as OSK (On Screen Keyboard) is used as the keyboard, it is difficult for the user to touch type the Tab key or the arrow key. Further, when resuming typing after selecting the prediction candidate, there is a need for the user to visually check the position of the keyboard and determine the home position again. Therefore, in the conventional information processing apparatus, it is difficult to improve the productivity of key input using the predictive input function.

### SUMMARY OF THE INVENTION

One or more embodiments provide an information processing apparatus and a control method capable of improving the productivity of text input using a predictive input function.

An information processing apparatus according to the first aspect of the present invention includes: a keyboard and a touch pad; a display unit (display) which displays input information input through the keyboard and the touch pad; an input conversion processing unit (input conversion processor) which displays, on the display unit, input prediction candidates for key input through the keyboard; and a switching processing unit (switching processor) which switches the touch pad from a normal input mode to perform input processing as a normal pointing device to a gesture input mode to output a key code corresponding to each of specific keys including at least arrow keys and an enter key as a specific key corresponding to a specific gesture according to the specific gesture as a specific touch operation on the touch pad during a period in which the input conversion processing unit is displaying the input prediction candidates on the display unit.

The above information processing apparatus according to the first aspect of the present invention may further include an input processing unit (input processor) which processes input on the touch pad by switching between input processing in the normal input mode and input processing in the gesture input mode, wherein when the input prediction candidates are displayed on the display unit, the switching processing unit causes the input processing unit to change from the input processing in the normal input mode to the input processing in the gesture input mode, and when the input prediction candidates are hidden, the switching processing unit causes the input processing unit to return to the input processing in the normal input mode from the input processing in the gesture input mode.

The above information processing apparatus according to the first aspect of the present invention may further include: a main system which executes processing based on an OS (operating system); and an embedded system which is different from and independent of the main system, wherein the keyboard is a software keyboard, the main system includes the input conversion processing unit and the switching processing unit, and the embedded system includes the input processing unit to output a key code detected on the software keyboard to the main system using a generic interface protected by the main system.

Further, the above information processing apparatus according to the first aspect of the present invention may be such that the specific touch operation includes an operation to move a user's finger on the touch pad in any one of up, down, left, and right directions, and in the gesture input mode, the input processing unit outputs a key code of an arrow key corresponding to a moving direction according to the operation to move the finger on the touch pad in any one of up, down, left, and right directions.

Further, the above information processing apparatus according to the first aspect of the present invention may be such that the input processing unit determines the any one of up, down, left, and right directions based on the aspect ratio of a moving trajectory of the finger on the touch pad.

Further, the above information processing apparatus according to the first aspect of the present invention may be such that the specific touch operation includes a tap operation on the touch pad, and the input processing unit outputs a key code of the enter key in the gesture input mode according to the tap operation.

Further, the above information processing apparatus according to the first aspect of the present invention may be such that the switching processing unit determines that the input conversion processing unit is displaying the input prediction candidates on the display unit based on a window message issued while the input prediction candidates are being displayed.

Further, a control method for an information processing apparatus according to the second aspect of the present invention is a control method for an information processing apparatus including: a keyboard and a touch pad; and a display unit (display) which displays input information input through the keyboard and the touch pad, the control method including: an input conversion step of causing an input conversion processing unit (input conversion processor) to display, on the display unit, input prediction candidates for key input through the keyboard; and a switching step of causing a switching processing unit (switching processor) to switch the touch pad from a normal input mode to perform input processing as a normal pointing device to a gesture input mode to output a key code corresponding to each of specific keys including at least arrow keys and an enter key as a specific key corresponding to a specific gesture according to the specific gesture as a specific touch operation on the touch pad during a period in which the input conversion processing unit is displaying the input prediction candidates on the display unit.

The above-described aspects of the present invention can improve the productivity of key input using a predictive input function.

### BRIEF DESCRIPTION OF THE DRAWINGS

FIG. 1 is an external view illustrating an example of a laptop PC according to a first embodiment.

FIG. 2 is a diagram illustrating an example of the main hardware configuration of the laptop PC according to the first embodiment.

FIG. 3 is a block diagram illustrating an example of the functional configuration of the laptop PC according to the first embodiment.

FIG. 4 is a table illustrating examples of gesture operations on a touch pad of the laptop PC and key codes according to the first embodiment.

FIG. 5 is a flowchart illustrating an example of mode switching processing of the touch pad of the laptop PC according to the first embodiment.

FIG. 6 is a flowchart illustrating an example of processing in a gesture input mode of the laptop PC according to the first embodiment.

FIG. 7 is a diagram illustrating an example of processing in the gesture input mode of the laptop PC according to the first embodiment.

FIG. 8 is an external view illustrating an example of a laptop PC according to a second embodiment.

FIG. 9 is a diagram illustrating an example of the main hardware configuration of the laptop PC according to the second embodiment.

FIG. 10 is a block diagram illustrating an example of the functional configuration of the laptop PC according to the second embodiment.

### DETAILED DESCRIPTION OF THE INVENTION

An information processing apparatus and a control method according to one or more embodiments of the present invention will be described below with reference to the accompanying drawings.

### First Embodiment

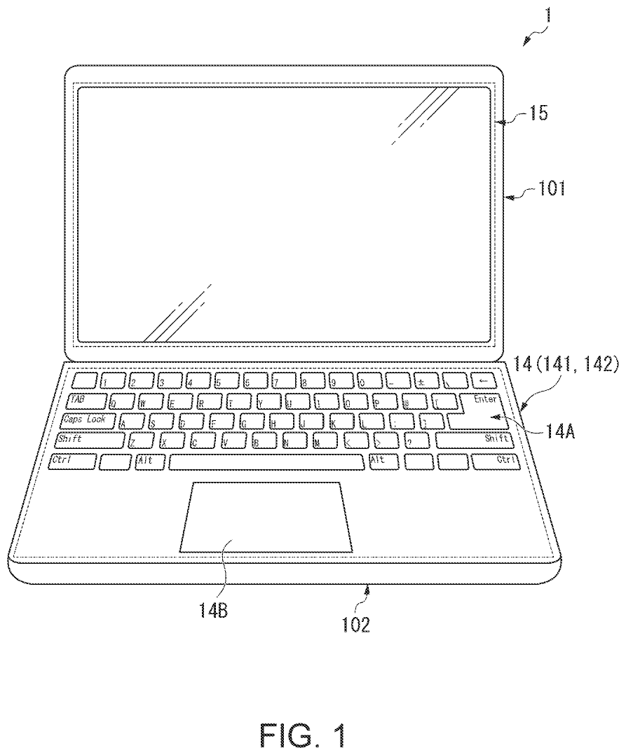

FIG. 1 is an external view illustrating an example of a laptop PC 1 according to a first embodiment. Note that the laptop PC 1 will be described in the present embodiment as an example of the information processing apparatus.

As illustrated in FIG. 1, the laptop PC 1 includes a first chassis 101 and a second chassis 102, which are so constructed that a side face of one chassis (first chassis 101) is coupled to a side face of the other chassis (second chassis 102) by a hinge mechanism in such a manner that the first chassis 101 is rotatable around an axis of rotation of the hinge mechanism relative to the second chassis 102.

Further, the laptop PC 1 includes a touch screen 14 and a display unit 15. The display unit 15 is placed on the first chassis 101 to function as a main display unit. The touch screen 14 is placed on the second chassis 102 to include a display unit 141 and a touch sensor unit 142.

Further, in the present embodiment, a keyboard 14A and a touch pad 14B as virtual input devices are realized by the touch screen 14 placed on the second chassis 102. In the present embodiment, an example when the keyboard 14A is a software keyboard such as OSK will be described.

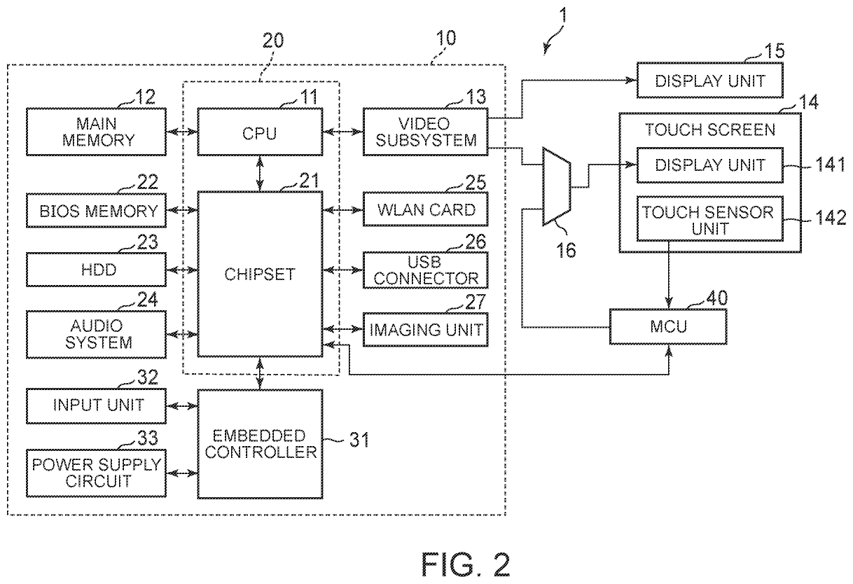

FIG. 2 is a diagram illustrating an example of the main hardware configuration of the laptop PC 1 according to the present embodiment.

As illustrated in FIG. 2, the laptop PC 1 includes a CPU 11, a main memory 12, a video subsystem 13, the touch screen 14, the display unit 15, a switching unit 16, a chipset 21, a BIOS memory 22, an HDD 23, an audio system 24, a WLAN card 25, a USB connector 26, an imaging unit 27, an embedded controller 31, an input unit 32, a power supply circuit 33, and an MCU (Micro Control Unit) 40.

Note that the CPU 11, the main memory 12, the video subsystem 13, the chipset 21, the BIOS memory 22, the HDD 23, the audio system 24, the WLAN card 25, the USB connector 26, the imaging unit 27, the embedded controller 31, the input unit 32, and the power supply circuit 33 in the present embodiment correspond to a main system 10 that executes processing based on an OS (operating system).

The main system 10 executes various processing based, for example, on Windows (registered trademark).

The CPU (Central Processing Unit) 11 executes various kinds of arithmetic processing by program control to control the entire laptop PC 1.

The main memory 12 is a writable memory used as reading areas of execution programs of the CPU 11 or working areas to which processing data of the execution programs are written. The main memory 12 is composed, for example, of plural DRAM (Dynamic Random Access Memory) chips. The execution programs include the OS, various drivers for hardware-operating peripheral devices, various services/utilities, application programs, and the like.

The video subsystem 13 is a subsystem for realizing a function related to image display, which includes a video controller. This video controller processes a drawing command from the CPU 11, writes processed drawing information into a video memory, and reads this drawing information from the video memory to output the drawing information to the display unit 15 and the display unit 141 as drawing data (image data). For example, the video subsystem 13 outputs the drawing information through the HDMI (High-Definition Multimedia Interface (registered trademark)) or a DP (Display Port).

As illustrated in FIG. 1, the touch screen 14 is placed on the second chassis 102, and includes the display unit 141 and the touch sensor unit 142.

The display unit 141 is, for example, a liquid crystal display or an electronic paper to display image data on the display screen. The display unit 141 is mainly used for the display of the virtual input devices of the keyboard 14A and the touch pad 14B.

The touch sensor unit 142 is placed in a manner to be overlaid on the display screen of the display unit 141 to detect a touch of an object (an operating medium such as part of a human body (for example, a finger)) on the display screen of the display unit 141. The touch sensor unit 142 is, for example, a capacitive touch sensor capable of detecting the touch of an object.

The display unit 15 is placed on the first chassis 101 to function as the main display unit of the laptop PC 1. For example, the display unit 15 is a liquid crystal display or an organic EL display to display image data on the display screen.

The switching unit 16 is, for example, a toggle switch to switch between image data output from the MCU 40 and image data output from the main system 10 in order to output image data to the display unit 141. The switching unit 16 is used when the main system 10 uses the display unit 141 of the touch screen 14.

The chipset 21 includes controllers, such as USB (Universal Serial Bus), serial ATA (AT Attachment), an SPI (Serial Peripheral Interface) bus, a PCI (Peripheral Component Interconnect) bus, a PCI-Express bus, and an LPC (Low Pin Count) bus, and plural devices are connected to the chipset 21. In FIG. 2, the BIOS memory 22, the HDD 23, the audio system 24, the WLAN card 25, the USB connector 26, and the imaging unit 27 are connected to the chipset 21 as an example of the plural devices.

Note that the CPU 11 and the chipset 21 configure a main control unit 20 in the present embodiment.

The BIOS (Basic Input Output System) memory 22 is configured, for example, by an electrically rewritable nonvolatile memory such as an EEPROM (Electrically Erasable Programmable Read Only Memory) or a flash ROM. The BIOS memory 22 stores a BIOS, system firmware for controlling the embedded controller 31, and the like.

The HDD (Hard Disk Drive) 23 (an example of a nonvolatile storage device) stores the OS, various drivers, various services/utilities, application programs, and various data.

The audio system 24 records, plays back, and outputs sound data.

The WLAN (Wireless Local Area Network) card 25 is connected to a network through wireless LAN to perform data communication. For example, when receiving data from the network, the WLAN card 25 generates an event trigger indicating that the data is received.

The USB connector 26 is a connector for connecting peripheral devices using the USB.

The imaging unit 27 is, for example, a webcam to capture images. For example, the imaging unit 27 is connected to the chipset 21 through a USB interface.

The embedded controller 31 is a one-chip microcomputer which monitors and controls various devices (peripheral devices, sensors, and the like) regardless of the system state of the laptop PC 1. Further, the embedded controller 31 has a power management function to control the power supply circuit 33. Note that the embedded controller 31 is composed of a CPU, a ROM, a RAM, and the like, and includes multi-channel A/D input terminal and D/A output terminal, a timer, and digital input/output terminals, which are not illustrated. To the embedded controller 31, for example, the input unit 32, the power supply circuit 33, and the like are connected through these input/output terminals. The embedded controller 31 controls the operation of these units. Note that the embedded controller 31 is an example of a sub-control unit.

The input unit 32 is, for example, a control switch such as a power switch.

The power supply circuit 33 includes, for example, a DC/DC converter, a charge/discharge unit, a buttery unit, an AC/DC adapter, and the like to convert DC voltage supplied from the AC/DC adapter or the battery unit into plural voltages required to operate the laptop PC 1. Further, the power supply circuit 33 supplies power to each unit of the laptop PC 1 under the control of the embedded controller 31.

The MCU 40 is, for example, a processor including a CPU and the like to function as an embedded system (sub-system) different from and independent of the main system 10 by executing built-in firmware. For example, the MCU 40 is connected to the chipset 21 through the USB interface.

The MCU 40 outputs input information (for example, a key code or touch pad information) based on detection information, detected by the touch sensor unit 142 as the keyboard 14A and the touch pad 14B, to the main system 10 (chipset 21) using a generic interface (for example, in USB HID (Human Interface Device) class) protected by the main system 10.

Further, the MCU 40 generates image data for the keyboard 14A and the touch pad 14B, and displays the image data on the display unit 141, for example, as illustrated in FIG. 1.

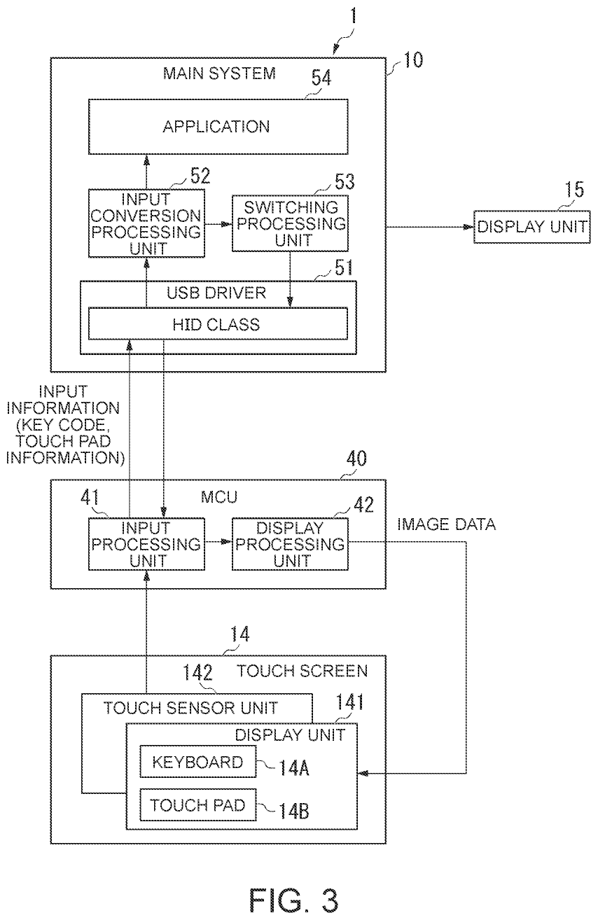

Note that the details of the MCU 40 will be described later with reference to FIG. 3.

Referring next to FIG. 3, the functional configuration of the laptop PC 1 according to the present embodiment will be described.

FIG. 3 is a block diagram illustrating an example of the functional configuration of the laptop PC 1 according to the present embodiment.

As illustrated in FIG. 3, the laptop PC 1 includes the main system 10, the touch screen 14, the display unit 15, and the MCU 40. Note that only the main functional configuration related to the invention of the present embodiment is illustrated in FIG. 3 as the configuration of the laptop PC 1.

The main system 10 executes processing based on the OS to display, on the display unit 15, information related to the processing.

Further, the main system 10 includes a USB driver 51 of the main system 10, an input conversion processing unit (input conversion processor) 52, a switching processing unit (switching processor) 53, and an application 54.

The USB driver 51 is a functional unit implemented by the CPU 11 and the chipset 21 to control the USB interface. In the present embodiment, the HID class is used as the USB interface to input key codes and the like from the touch sensor unit 142.

The input conversion processing unit 52 is a functional unit implemented by the CPU 11 and the chipset 21. The input conversion processing unit 52 is, for example, a FEP (Front-End Processor) or an IME (Input Method Editor) to execute processing such as kana-kanji conversion for input from the keyboard 14A and the touch pad 14B. Further, for example, the input conversion processing unit 52 displays, on the display unit 15, input prediction candidates for key input through the keyboard 14A.

Note that the input conversion processing unit 52 issues a window message (for example, WM_IME_NOTIFY) while the input prediction candidates are being displayed.

The switching processing unit 53 is a functional unit implemented by the CPU 11 and the chipset 21. During a period in which the input conversion processing unit 52 is displaying the input prediction candidates on the display unit 15, the switching processing unit 53 switches the control of the touch pad 14B from a normal input mode to a gesture input mode. Here, the normal input mode is an input mode to perform input processing using the touch pad 14B as a normal pointing device.

Further, in the gesture input mode, a key code of each of specific keys corresponding to a specific gesture is output according to the specific gesture as a specific touch operation on the touch pad 14B. The specific keys include at least arrow keys (up arrow key, down arrow key, right arrow key, and left arrow key), and an Enter key.

Further, the switching processing unit 53 determines that the input prediction candidates are being displayed on the display unit 15 based on the window message (for example, WM_IME_NOTIFY) issued by the input conversion processing unit 52 during displaying the input prediction candidates.

When the input prediction candidates are displayed on the display unit 15, the switching processing unit 53 causes an input processing unit (input processor) 41 of the MCU 40 to be described later to change from input processing in the normal input mode to input processing in the gesture input mode. Further, when the input prediction candidates are hidden, the switching processing unit 53 causes the input processing unit 41 of the MCU 40 to be described later to return to the input processing in the normal input mode from the input processing in the gesture input mode. The switching processing unit 53 uses a USB custom HID class to switch the input mode of the input processing unit 41 of the MCU 40 to be described later.

The application 54 is a functional unit implemented by the CPU 11 and the chipset 21 to accept information input using the input conversion processing unit 52 and execute various processing. Note that the application 54 raises a WM_IME_NOTIFY flag according to the window message (WM_IME_NOTIFY) issued by the input conversion processing unit 52 described above to detect that the input prediction candidates are being displayed.

The MCU 40 (an example of an embedded system) controls the keyboard 14A and the touch pad 14B as virtual input devices realized by the touch screen 14. For example, the MCU 40 generates image data of areas of the keyboard 14A and the touch pad 14B, displays the image data of the areas on the display unit 141, and accepts detection information from the touch sensor unit 142 in the areas, respectively. The MCU 40 outputs, to the main system 10, input information (for example, key codes and the like) based on the detection information on the keyboard 14A and the touch pad 14B.

The MCU 40 includes the input processing unit 41 and a display processing unit 42.

The input processing unit 41 is a functional unit implemented by the MCU 40. The input processing unit 41 executes input processing of the keyboard 14A and the touch pad 14B. The input processing unit 41 generates a key code corresponding to input according to the input on the keyboard 14A, and transmits the generated key code to the main system 10 using the HID class of the USB interface. Further, the input processing unit 41 transmits a key code of input information of the pointing device corresponding to input according to the input on the touch pad 14B to the main system 10 using the HID class of the USB interface.

Note that the input processing unit 41 switches between the input processing in the normal input mode and the input processing in the gesture input mode to process the input on the touch pad 14B. In the normal input mode, the input processing unit 41 performs input processing by using the touch pad 14B as a normal pointing device.

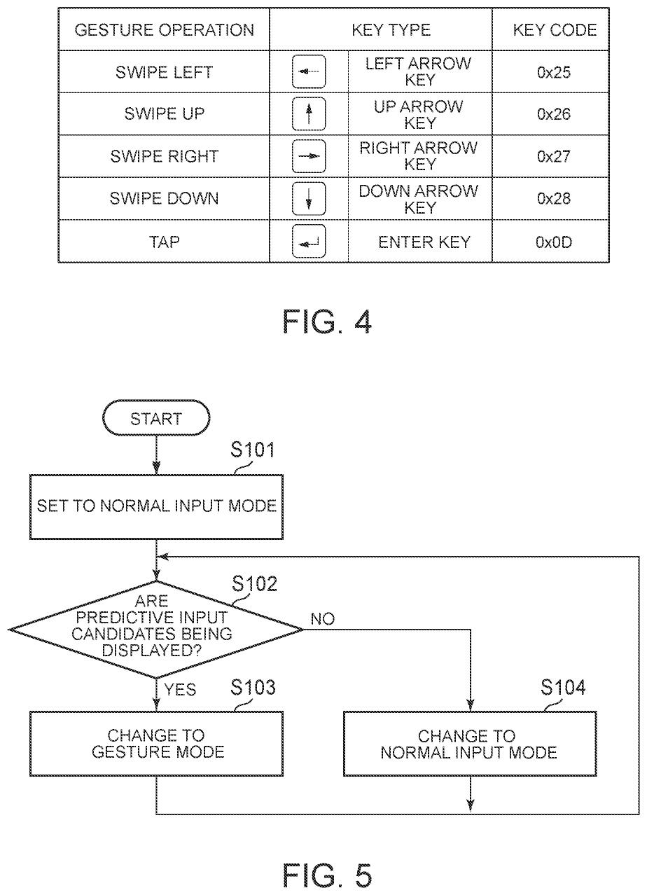

Further, in the gesture input mode, the input processing unit 41 transmits a key code of a specific key corresponding to a specific gesture according to the specific gesture as a specific touch operation on the touch pad 14B to the main system 10 using the HID class of the USB interface. Referring here to FIG. 4, examples of gesture operations on the touch pad 14B and key codes in the gesture input mode will be described.

FIG. 4 is a table illustrating examples of gesture operations on the touch pad 14B of the laptop PC 1 and key codes according to the present embodiment.

As illustrated in FIG. 4, when the gesture operation in the gesture input mode is a swipe left, the input processing unit 41 determines that the key type is the left arrow key (“←” key), and transmits a key code “0x25” to the main system 10.

Further, when the gesture operation in the gesture input mode is a swipe up, the input processing unit 41 determines that the key type is the up arrow key (“↑” key), and transmits a key code “0x26” to the main system 10.

Further, when the gesture operation in the gesture input mode is a swipe right, the input processing unit 41 determines that the key type is the right arrow key (“→” key), and transmits a key code “0x27” to the main system 10.

Further, when the gesture operation in the gesture input mode is a swipe down, the input processing unit 41 determines that the key type is the down arrow key (“↓” key), and transmits a key code “0x28” to the main system 10.

Further, when the gesture operation in the gesture input mode is a tap, the input processing unit 41 determines that the key type is the Enter key, and transmits a key code “0x0D” to the main system 10.

Here, the swipe is an operation of stroking a finger in a specific direction while keeping the finger touching the touch pad 14B. In the gesture input mode, the input processing unit 41 outputs the key code of an arrow key corresponding to a moving direction according to the operation of moving the finger on the touch pad 14B in any one of up, down, left, and right directions. The input processing unit 41 determines, from the aspect ratio of the swipe, in which of the up, down, left, and right directions the swipe is. In other words, based on the aspect ratio of the moving trajectory of the finger on the touch pad 14B, the input processing unit 41 determines the any one of the up, down, left, and right directions.

Note that the aspect ratio is a vertical to horizontal ratio, which means the vertical to horizontal ratio of the moving trajectory of the swipe here.

Further, the tap is an operation of touching the touch pad 14B lightly with a finger. In the gesture input mode, the input processing unit 41 outputs the key code of the Enter key according to the tap operation.

Returning to the description of FIG. 3, when a key of the keyboard 14A of the virtual input device is pressed down, the input processing unit 41 converts detection information detected by the touch sensor unit 142 into a corresponding key code, and transmits the key code to the main system 10 using the HID class of the USB interface.

Further, the input processing unit 41 outputs, to the display processing unit 42, the detection information obtained by pressing down the key on the keyboard 14A to generate feedback image data according to the detection information.

The display processing unit 42 is a functional unit implemented by the MCU 40. The display processing unit 42 generates image data of the keyboard 14A and the touch pad 14B, and displays the generated image data on the display unit 141.

Further, when receiving the detection information obtained by pressing down the key on the keyboard 14A output by the input processing unit 41 described above, the display processing unit 42 generates input feedback image data obtained, for example, by reversing the position of the image corresponding to the position of the key pressed down on the keyboard 14A, or the like. The display processing unit 42 displays the generated input feedback image data on the display unit 141.

Next, the operation of the laptop PC 1 according to the present embodiment will be described with reference to the accompanying drawings.

FIG. 5 is a flowchart illustrating an example of mode switching processing of the touch pad 14B of the laptop PC 1 according to the present embodiment.

As illustrated in FIG. 5, the switching processing unit 53 of the laptop PC 1 first sets the input mode to the normal input mode (step S101). In other words, the switching processing unit 53 sets the input processing unit 41 of the MCU 40 to the normal input mode.

Next, the switching processing unit 53 determines whether or not predictive input candidates are being displayed (step S102). For example, the switching processing unit 53 checks the flag of the window message (for example, WM_IME_NOTIFY) as the flag of the application 54 and issued by the input conversion processing unit 52 while the input prediction candidates are being displayed, and determines whether or not the input conversion processing unit 52 is displaying the predictive input candidates on the display unit 15. When the predictive input candidates are being displayed (step S102: YES), the switching processing unit 53 proceeds to step S103. On the other hand, when the predictive input candidates are not being displayed (step S102: NO), the switching processing unit 53 proceeds to a process in step S104.

In step S103, the switching processing unit 53 changes the input mode to the gesture input mode. In other words, the switching processing unit 53 changes the input mode of the input processing unit 41 of the MCU 40 to the gesture input mode. After the process in step S103, the switching processing unit 53 returns to the process in step S102.

Further, in step S104, the switching processing unit 53 changes the input mode to the normal input mode. In other words, the switching processing unit 53 changes the input mode of the input processing unit 41 of the MCU 40 to the normal input mode. After the process in step S104, the switching processing unit 53 returns to the process in step S102.

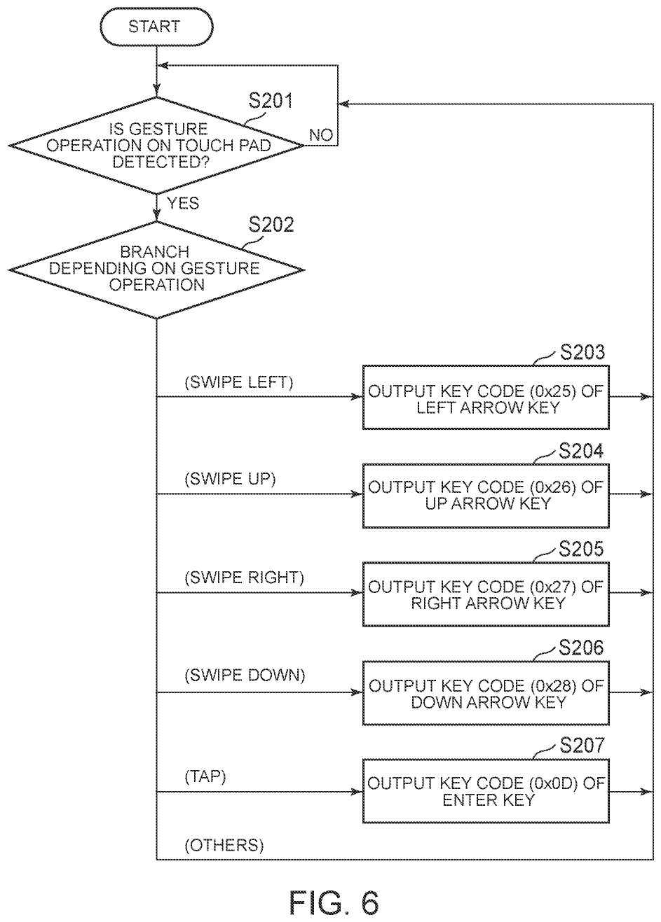

Referring next to FIG. 6, processing in the gesture input mode of the laptop PC 1 according to the present embodiment will be described.

FIG. 6 is a flowchart illustrating an example of processing in the gesture input mode of the laptop PC 1 according to the present embodiment. Here, processing when the input processing unit 41 of the MCU 40 is in the gesture input mode will be described.

The MCU 40 of the laptop PC 1 determines whether or not a gesture on the touch pad 14B is detected (step S201). In the gesture input mode, the input processing unit 41 of the MCU 40 determines whether or not a gesture operation is detected in the area of the touch pad 14B of the touch sensor unit 142. When detecting a gesture on the touch pad 14B (step S201: YES), the input processing unit 41 proceeds to a process in step S202. On the other hand, when detecting no gesture on the touch pad 14B (step S201: NO), the input processing unit 41 returns to the process in step S201.

In step S202, the input processing unit 41 executes branch processing depending on the gesture operation. When the gesture operation is the swipe left, the input processing unit 41 proceeds to a process in step S203.

Further, when the gesture operation is the swipe up, the input processing unit 41 proceeds to a process in step S204.

Further, when the gesture operation is the swipe right, the input processing unit 41 proceeds to a process in step S205.

Further, when the gesture operation is the swipe down, the input processing unit 41 proceeds to a process in step S206.

Further, when the gesture operation is the tap, the input processing unit 41 proceeds to a process in step S207.

Further, when the gesture operation is any other operation, the input processing unit 41 returns to the process in step S201.

In step S203 in which the gesture operation is the swipe left, the input processing unit 41 outputs a key code (0x25) of the left arrow key. In other words, the input processing unit 41 uses the USB HID class to transmit the key code (0x25) of the left arrow key to the main system 10. After the process in step S203, the input processing unit 41 returns to the process in step S201.

In step S204 in which the gesture operation is the swipe up, the input processing unit 41 outputs a key code (0x26) of the up arrow key to the main system 10. In other words, the input processing unit 41 uses the USB HID class to transmit the key code (0x26) of the up arrow key to the main system 10. After the process in step S204, the input processing unit 41 returns to the process in step S201.

In step S205 in which the gesture operation is the swipe right, the input processing unit 41 outputs a key code (0x27) of the right arrow key. In other words, the input processing unit 41 uses the USB HID class to transmit the key code (0x27) of the right arrow key to the main system 10. After the process in step S205, the input processing unit 41 returns to the process in step S201.

In step S206 in which the gesture operation is the swipe down, the input processing unit 41 outputs a key code (0x28) of the down arrow key. In other words, the input processing unit 41 uses the USB HID class to transmit the key code (0x28) of the down arrow key to the main system 10. After the process in step S206, the input processing unit 41 returns to the process in step S201.

In step S207 in which the gesture operation is the tap, the input processing unit 41 outputs a key code (0x0D) of the Enter key. In other words, the input processing unit 41 uses the USB HID class to transmit the key code (0x0D) of the Enter key to the main system 10. After the process in step S207, the input processing unit 41 returns to the process in step S201.

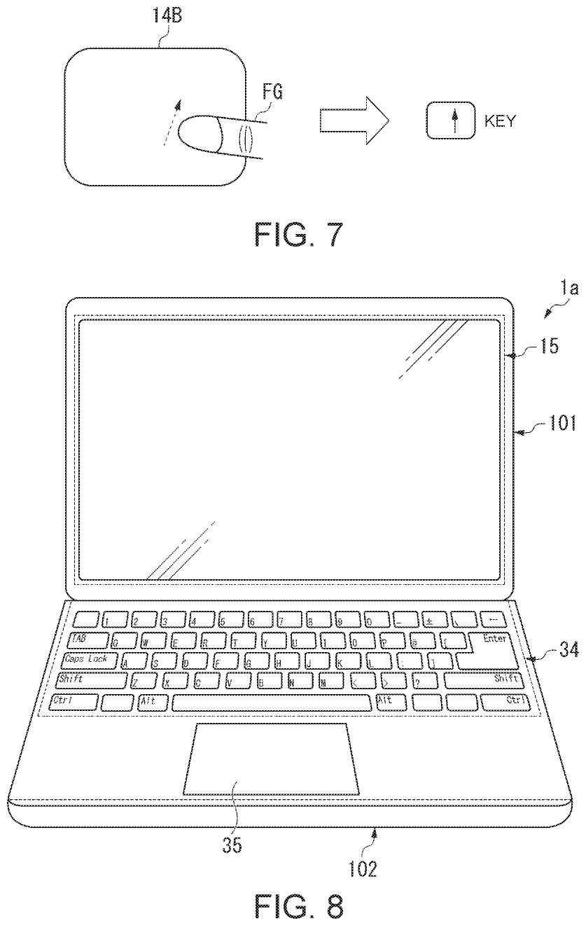

Referring here to FIG. 7, a specific example of processing in the gesture input mode of the laptop PC 1 according to the present embodiment will be described.

FIG. 7 is a diagram illustrating an example of processing in the gesture input mode of the laptop PC 1 according to the present embodiment.

In the example illustrated in FIG. 7, when a user's finger FG is swiped up from the bottom on the touch pad 14B in the gesture input mode, the input processing unit 41 outputs the key code of the up arrow key to the main system 10.

As described above, the laptop PC 1 (information processing apparatus) according to the present embodiment includes: the keyboard 14A and the touch pad 14B; the display unit 15; the input conversion processing unit 52; and the switching processing unit 53. The display unit 15 displays input information input through the keyboard 14A and the touch pad 14B. The input conversion processing unit 52 displays, on the display unit 15, input prediction candidates for key through the keyboard 14A. The switching processing unit 53 switches the touch pad 14B from the normal input mode to the gesture input mode during the period in which the input conversion processing unit 52 is displaying the input prediction candidates on the display unit 15. Here, the normal input mode is an input mode to perform input processing as the normal pointing device. The gesture input mode is an input mode to output a key code corresponding to each of specific keys including at least the arrow keys and the Enter key as a specific key corresponding to a specific gesture according to the specific gesture as a specific touch operation on the touch pad 14B.

Thus, the laptop PC 1 according to the present embodiment can reduce the possibility that user's hands are moved away, for example, from the home position of the keyboard by the gesture operation on the touch pad 14B in the gesture input mode, and hence can select an input prediction candidate. Therefore, since the user does not need to visually check the position of the keyboard 14A and determine the home position again, touch-typing can be kept, and the laptop PC 1 according to the present embodiment can improve the productivity of key input using a predictive input function.

Further, in the laptop PC 1 according to the present embodiment, the user does not need to perform a precise gesture operation on the touch pad 14B, and can select an input prediction candidate with a simple gesture operation. For example, since the gesture operation can be performed on the touch pad 14B with a user's thumb, the user can perform an operation to select an input prediction candidate easily while looking at the screen of the display unit 15 (without looking at his or her hands) on the laptop PC 1 according to the present embodiment.

Further, especially when using a software keyboard like the OSK as the keyboard 14A, the laptop PC 1 according to the present embodiment allows the user to keep touch typing, and hence can improve the productivity of key input using the predictive input function.

Further, the laptop PC 1 according to the present embodiment includes the input processing unit 41 that processes input on the touch pad 14B by switching between the input processing in the normal input mode and the input processing in the gesture input mode. When the input prediction candidates are displayed on the display unit 15, the switching processing unit 53 causes the input processing unit 41 to change from the input processing in the normal input mode to the input processing in the gesture input mode. Further, when the input prediction candidates are hidden, the switching processing unit 53 returns to the input processing in the normal input mode from the input processing in the gesture input mode.

Thus, when the input prediction candidates are displayed on the display unit 15, the laptop PC 1 according to the present embodiment can switch between the input modes of the input processing unit 41 properly, and hence can improve the productivity of key input using the predictive input function.

Further, the laptop PC 1 according to the present embodiment includes the main system 10 that executes processing based on the OS, and the MCU 40 (embedded system) different from and independent of the main system 10. Further, the keyboard 14A is a software keyboard. The main system 10 includes the input conversion processing unit 52 and the switching processing unit 53. The MCU 40 includes the input processing unit 41 that outputs a key code detected on the software keyboard to the main system 10 using the generic interface (for example, USB HID class) protected by the main system 10.

Thus, since the laptop PC 1 according to the present embodiment realizes the software keyboard, for example, by processing inside the independent MCU 40, a virtual input device with a high degree of freedom without being restricted by the OS (for example, Windows (registered trademark)) of the main system 10 can be realized.

Further, since the key code detected on the software keyboard is output to the main system 10 using the generic interface protected by the main system 10, the laptop PC 1 according to the present embodiment can reduce the risk of interference with any other software. In other words, for example, even when the OS of the main system 10 is infected with a computer virus or malware, the user does not need to worry about input to the virtual input device being read in the laptop PC 1 according to the present embodiment. Therefore, the laptop PC 1 according to the present embodiment can realize the virtual input device with a high degree of freedom while protecting the user's privacy.

Further, in the present embodiment, an operation to move a user's finger in any one of up, down, left and right directions on the touch pad 14B is included as the specific touch operations. In the gesture input mode, the input processing unit 41 outputs the key code of an arrow key corresponding to the moving direction according to an operation (for example, the swipe) to move the finger in any one of the up, down, left and right directions on the touch pad 14B.

Thus, the laptop PC 1 according to the present embodiment allows the user to perform an operation (for example, the swipe) to move the finger in any one of the up, down, left and right directions on the touch pad 14B so that the user can move the cursor up, down, left, or right to select an input prediction candidate easily without moving his or her hands away, for example, from the home position of the keyboard 14A.

Further, in the present embodiment, the input processing unit 41 determines any one of the up, down, left, and right directions based on the aspect ratio of the moving trajectory of the finger on the touch pad 14B.

Thus, the laptop PC 1 according to the present embodiment can easily determine an operation to move the finger on the touch pad 14B in any one of the up, down, left, and right directions (for example, in a swipe direction).

Further, in the present embodiment, a tap operation on the touch pad 14B is included in the specific touch operations. In the gesture input mode, the input processing unit 41 outputs the key code of the Enter key according to the tap operation.

Thus, the laptop PC 1 according to the present embodiment allows the user to perform the tap operation on the touch pad 14B with the finger to select an input prediction candidate easily without moving his or her hands away, for example, from the home position of the keyboard 14A.

Further, the laptop PC 1 according to the present embodiment includes the switching unit 16 that switches between image data output by the MCU 40 and image data output by the main system 10 to output the image data to the display unit 141.

Thus, the laptop PC 1 according to the present embodiment can switch between image data of the keyboard 14A and the touch pad 14B, and image data from the main system 10 to display an image on the display unit 141, and hence can increase the display flexibility of the display unit 141.

Further, a control method according to the present embodiment is a control method for the laptop PC 1 (information processing apparatus) including: the keyboard 14A and the touch pad 14B; and the display unit 15 that displays input information input through the keyboard 14A and the touch pad 14B, the control method including an input conversion step and a switching step. In the input conversion step, the input conversion processing unit 52 displays, on the display unit 15, input prediction candidates for key input through the keyboard 14A. In the switching step, the switching processing unit 53 switches the touch pad 14B from the normal input mode to the gesture input mode during the period in which the input conversion processing unit 52 is displaying the input prediction candidates on the display unit 15.

Thus, the control method for the laptop PC 1 according to the present embodiment has the same effect as the laptop PC 1 described above, and hence can improve the productivity of key input using the predictive input function.

### Second Embodiment

Next, a laptop PC 1a according to a second embodiment will be described with reference to the accompanying drawings.

In the second embodiment, a modification when the laptop PC 1a includes a physical keyboard 34 and a physical touch pad 35 which are not virtual input devices will be described.

FIG. 8 is an external view illustrating an example of the laptop PC 1a according to the second embodiment. Note that the laptop PC 1a will be described in the present embodiment as an example of the information processing apparatus.

As illustrated in FIG. 8, the laptop PC 1a includes the first chassis 101 and the second chassis 102, which are so constructed that a side face of one chassis (first chassis 101) is coupled to a side face of the other chassis (second chassis 102) by a hinge mechanism in such a manner that the first chassis 101 is rotatable around an axis of rotation of the hinge mechanism relative to the second chassis 102.

Further, the laptop PC 1a includes the display unit 15, the keyboard 34, and the touch pad 35. The display unit 15 is placed on the first chassis 101 to function as a main display unit.

The keyboard 34 is a physical keyboard, which is placed on the second chassis 102. Further, the touch pad 35 is placed on the second chassis 102 to function as a pointing device.

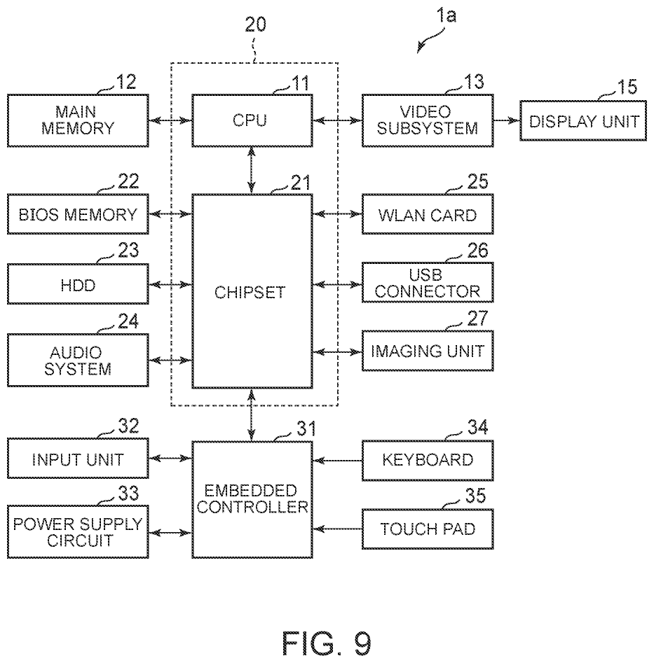

FIG. 9 is a diagram illustrating an example of the main hardware configuration of the laptop PC 1a according to the present embodiment.

As illustrated in FIG. 9, the laptop PC 1a includes the CPU 11, the main memory 12, the video subsystem 13, the display unit 15, the chipset 21, the BIOS memory 22, the HDD 23, the audio system 24, the WLAN card 25, the USB connector 26, the imaging unit 27, the embedded controller 31, the input unit 32, the power supply circuit 33, the keyboard 34, and the touch pad 35.

Note that the CPU 11 and the main memory 12 in the present embodiment correspond to the main control unit 20. The main control unit 20 executes various processing based, for example, on Windows (registered trademark).

Further, the present embodiment differs from the first embodiment in that the laptop PC 1a does not include the switching unit 16, the MCU 40, and the touch screen 14 (the display unit 141 and the touch sensor unit 142), and includes the keyboard 34 and the touch pad 35 instead.

Note that the same components in FIG. 9 as those in FIG. 2 described above are given the same reference numerals to omit the description thereof here.

The keyboard 34 is a physical keyboard placed on the second chassis 102 as illustrated in FIG. 8. The keyboard 34 is a built-in keyboard of the laptop PC 1a to accept key input from the user. The keyboard 34 is connected to the embedded controller 31, for example, through a PS/2 port.

The touch pad 35 is a physical touch pad placed on the second chassis 102 as illustrated in FIG. 8. The touch pad 35 is a built-in pointing device of the laptop PC 1a, which is connected to the embedded controller 31, for example, through the PS/2 port.

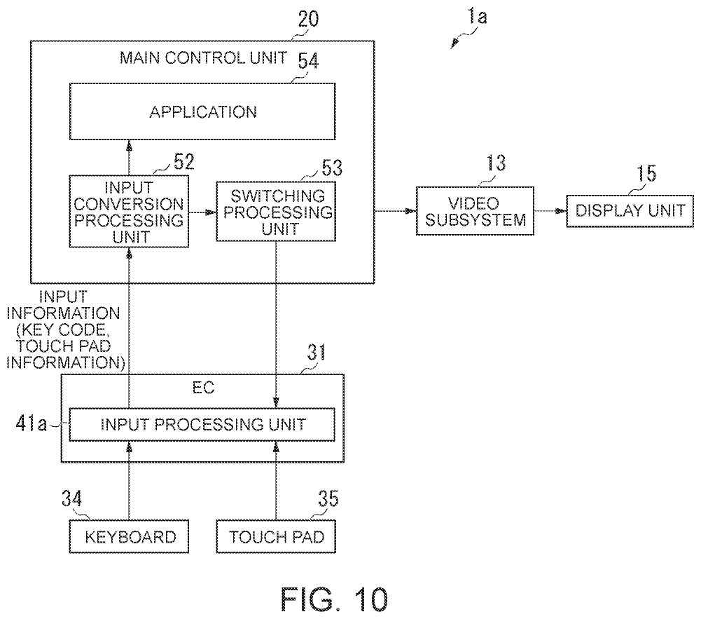

Referring next to FIG. 10, the functional configuration of the laptop PC 1a according to the present embodiment will be described.

FIG. 10 is a block diagram illustrating an example of the functional configuration of the laptop PC 1a according to the present embodiment.

As illustrated in FIG. 10, the laptop PC 1a includes the main control unit 20, the video subsystem 13, the display unit 15, the embedded controller 31, the keyboard 34, and the touch pad 35. Note that only the main functional configuration related to the invention of the present embodiment is illustrated in FIG. 10 as the configuration of the laptop PC 1a.

The main control unit 20 is a functional unit implemented by the CPU 11 and the chipset 21. The main control unit 20 executes processing based on the OS, and displays information related to the processing on the display unit 15.

Further, the main control unit 20 includes the USB driver 51, the input conversion processing unit 52, the switching processing unit 53, and the application 54.

Note that since the USB driver 51, the input conversion processing unit 52, the switching processing unit 53, and the application 54 are the same functional units as those in the first embodiment, the description thereof will be omitted here.

The input conversion unit 52 receives key codes from the keyboard 34 and the touch pad 35 through the embedded controller 31.

The switching processing unit 53 causes an input processing unit 41a of the embedded controller 31 to be described later to switch between the normal input mode and the gesture input mode.

The embedded controller 31 (sub-control unit) receives, through the PS/2 port, input information (for example, key codes and the like) output through the keyboard 34 and the touch pad 35, and transmits the received input information to the main control unit 20.

Further, the embedded controller 31 includes the input processing unit 41a.

The input processing unit 41a is a functional unit implemented by the embedded controller 31. The input processing unit 41a executes input processing of the keyboard 34 and the touch pad 35. The input processing unit 41a transmits a key code to the input conversion processing unit 52 of the main control unit 20 according to input on the keyboard 34. Further, the input processing unit 41a outputs, to the main control unit 20, the key code of an arrow key corresponding to a moving direction according to an operation to move a finger on the touch pad 35 in any one of up, down, left, and right directions in the gesture input mode.

Further, the input processing unit 41a outputs, to the main control unit 20, the key code of the Enter key according to the tap operation on the touch pad 35 in the gesture input mode.

Thus, in the gesture input mode, the input processing unit 41a executes the same processing as that in the first embodiment described above.

Next, the operation of the laptop PC 1a according to the present embodiment will be described.

Since mode switching processing of the touch pad 35 of the laptop PC 1a according to the present embodiment is the same as the processing illustrated in FIG. 5 described above, the description thereof will be omitted here. Note that in the mode switching processing according to the present embodiment, the switching processing unit 53 executes switching on the input mode of the input processing unit 41a of the embedded controller 31 instead of the input processing unit 41 of the MCU 40.

Further, since the processing in the gesture input mode of the laptop PC 1a according to the present embodiment is the same as the processing illustrated in FIG. 6 described above, the description thereof will be omitted here. Note that the touch pad 35 is used in the present embodiment instead of the touch pad 14B.

As described above, the laptop PC 1a (information processing apparatus) according to the present embodiment includes the keyboard 34 and the touch pad 35, the display unit 15, the input conversion processing unit 52, and the switching processing unit 53. The display unit 15 displays input information input through the keyboard 34 and the touch pad 35. The input conversion processing unit 52 displays, on the display unit 15, input prediction candidates for key input through the keyboard 34. The switching processing unit 53 switches the touch pad 35 from the normal input mode to the gesture input mode during the period in which the input conversion processing unit 52 is displaying the input prediction candidates on the display unit 15. Here, the normal input mode is an input mode to perform input processing as a normal pointing device. The gesture input mode is an input mode to output a key code corresponding to each of specific keys including at least the arrow keys and the Enter key as a specific key corresponding to a specific gesture as a specific touch operation on touch pad 35.

Thus, the laptop PC 1a according to the present embodiment has the same effect as the laptop PC 1 of the first embodiment described above, and hence can improve the productivity of key input using the predictive input function.

Further, the laptop PC 1a according to the present embodiment includes the main control unit 20 that executes processing based on the OS, and the embedded controller 31 (sub-control unit) different from the main control unit 20. Further, the keyboard 34 is the physical keyboard. The main control unit 20 includes the input conversion processing unit 52 and the switching processing unit 53. The embedded controller 31 includes the input processing unit 41a.

Thus, even in the case of the physical keyboard, the laptop PC 1a according to the present embodiment has the same effect, and hence can improve the productivity of key input using the predictive input function.

Further, the laptop PC 1 (1a) described above may be in the following form, namely: The laptop PC 1 (1a) described above includes the keyboard 14A (34) and the touch pad 14B (35), the display unit 15, the main memory 12 (memory) that temporarily stores a program, and a processor (main control unit 20) that executes the program stored in the memory (main memory 12). The processor (main control unit 20) executes the program stored in the memory (main memory 12) to execute input conversion processing to display, on the display unit 15, input prediction candidates for key input through the keyboard 14A (34), and switching processing to switch the touch pad 14B (35) from the normal input mode to the gesture input mode during the period in which the input prediction candidates are being displayed on the display unit 15 by the input conversion processing.

Thus, the laptop PC 1 (1a) described above has the same effect as the laptop PC 1 (1a) and the control method, and hence can improve the productivity of key input using the predictive input function.

Note that the present invention is not limited to the aforementioned respective embodiments, and changes can be made without departing from the scope of the present invention.

For example, in the aforementioned respective embodiments, the example in which the information processing apparatus is the laptop PC 1 (1a) is described, but the present invention is not limited to this example, and the information processing apparatus may also be any other information processing apparatus such as a tablet terminal or a smartphone.

Further, in the aforementioned respective embodiments, the example in which the input processing unit 41 (41a) detects a swipe or a tap as an example of the touch operation is described, but the present invention is not limited to this example, and any other tap operation may also be adopted. For example, the input processing unit 41 (41a) may also output the key code of the Enter key by a double tap.

Further, in the aforementioned respective embodiments, the example in which the input processing unit 41 (41a) outputs the key code of each of the arrow keys and the Enter key according to the specific gesture operation (touch operation) is described, but the present invention is not limited to this example. For example, the input processing unit 41 (41a) may also output a key code of any other key such as a TAB key.

Further, in the aforementioned respective embodiments, the example in which the display unit 15 is the normal display unit is described, but the present invention is not limited to this example, and the display unit 15 may also be configured by a touch screen including a touch sensor unit.

Further, in the aforementioned respective embodiments, the example in which a gesture operation corresponding to each of the arrow keys and the Enter key is accepted by the touch pad 14B (35) is described, but the present invention is not limited to this example, and a normal pointing device such as a mouse or a pointing stick may also be used instead of the touch pad 14B (35). Even in this case, the same effect as the laptop PC 1 (1a) can be obtained. Further, the keyboard is effective even when it is a software keyboard or a so-called physical keyboard.

Note that each configuration of the laptop PC 1 (1a) described above has a computer system therein. Then, a program for implementing the function of each component included in the laptop PC 1 (1a) described above may be recorded on a computer-readable recording medium so that the program recorded on this recording medium is read into the computer system and executed to perform processing in each component included in the laptop PC 1 (1a) described above. Here, the fact that “the program recorded on the recording medium is read into the computer system and executed” includes installing the program on the computer system. It is assumed that the “computer system” here includes the OS and hardware such as peripheral devices and the like.

Further, the “computer system” may include two or more computer devices connected through each of networks including the Internet, WAN, LAN, and a communication line such as a dedicated line. Further, the “computer-readable recording medium” means a storage medium such as a portable medium like a flexible disk, a magneto-optical disk, a flash ROM, or a CD-ROM, or a hard disk incorporated in the computer system. Thus, the recording medium with the program stored thereon may also be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the laptop PC 1 (1a), or delivery servers for delivering respective divided pieces of the program may be different from one another. Further, it is assumed that the “computer-readable recording medium” includes a medium on which the program is held for a given length of time, such as a volatile memory (RAM) inside a computer system as a server or a client when the program is transmitted through the network. The above-mentioned program may also be to implement some of the functions described above. Further, the program may be a so-called differential file (differential program) capable of implementing the above-described functions in combination with a program(s) already recorded in the computer system.

Further, some or all of the above-described functions may be realized as an integrated circuit such as LSI (Large Scale Integration). Each of the functions may be implemented as a processor individually, or some or all thereof may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

1, 1a laptop PC
10 main system
11 CPU
12 main memory
13 video subsystem
14 touch screen
14A, 34 keyboard
14B, 35 touch pad
15, 141 display unit
16 switching unit
20 main control unit
21 chipset
22 BIOS memory
23 HDD
24 audio system
25 WLAN card
26 USB connector
27 imaging unit
31 embedded controller (EC)
32 input unit
33 power supply circuit
40 MCU
41, 41a input processing unit
42 display processing unit
51 USB driver
52 input conversion processing unit
53 switching processing unit
54 application
101 first chassis
102 second chassis
142 touch sensor unit
FG finger

What is claimed is:

1. An information processing apparatus comprising:
a keyboard and a touch pad;
a display which displays input information input through the keyboard and the touch pad;
an input conversion processor which displays, on the display, input prediction candidates for key input through the keyboard; and
a switching processor which switches the touch pad from a normal input mode to perform input processing as a normal pointing device to a gesture input mode to output a key code corresponding to each of specific keys including at least arrow keys and an enter key as a specific key corresponding to a specific gesture according to the specific gesture as a specific touch operation on the touch pad during a period in which the input conversion processor is displaying the input prediction candidates on the display.

2. The information processing apparatus according to claim 1, further comprising:
an input processor which processes input on the touch pad by switching between input processing in the normal input mode and input processing in the gesture input mode, wherein
when the input prediction candidates are displayed on the display, the switching processor causes the input processor to change from the input processing in the normal input mode to the input processing in the gesture input mode, and
when the input prediction candidates are hidden, the switching processor causes the input processor to return to the input processing in the normal input mode from the input processing in the gesture input mode.

3. The information processing apparatus according to claim 2, further comprising:
a main system which executes processing based on an operating system (OS); and
an embedded system which is different from and independent of the main system, wherein
the keyboard is a software keyboard,
the main system includes the input conversion processor and the switching processor, and
the embedded system includes the input processor to output a key code detected on the software keyboard to the main system using a generic interface protected by the main system.

4. The information processing apparatus according to claim 3, wherein
the specific touch operation includes an operation to move a user's finger on the touch pad in any one of up, down, left, and right directions, and
in the gesture input mode, the input processor outputs a key code of an arrow key corresponding to a moving direction according to the operation to move the user's finger on the touch pad in any one of up, down, left, and right directions.

5. The information processing apparatus according to claim 4, wherein the input processor determines the any one of up, down, left, and right directions based on an aspect ratio of a moving trajectory of the user's finger on the touch pad.

6. The information processing apparatus according to claim 5, wherein
the specific touch operation includes a tap operation on the touch pad, and
the input processor outputs a key code of the enter key in the gesture input mode according to the tap operation.

7. The information processing apparatus according to claim 6, wherein the switching processor determines that the input conversion processor is displaying the input prediction candidates on the display based on a window message issued while the input prediction candidates are being displayed.

8. A control method for an information processing apparatus including: a keyboard and a touch pad; and a display which displays input information input through the keyboard and the touch pad, the control method comprises:
causing an input conversion processor to display, on the display, input prediction candidates for key input through the keyboard; and
causing a switching processor to switch the touch pad from a normal input mode to perform input processing as a normal pointing device to a gesture input mode to output a key code corresponding to each of specific keys including at least arrow keys and an enter key as a specific key corresponding to a specific gesture according to the specific gesture as a specific touch operation on the touch pad during a period in which the input conversion processor is displaying the input prediction candidates on the display.
